(19) United States
(12) Patent Application Publication
(10) Pub. No.: US 2013/0114805 A1
(43) Pub. Date: May 9, 2013

(54) ENCRYPTION SYSTEM USING DISCRETE CHAOS FUNCTION

(71) Applicants: Dae Woon Lim, Seoul (KR); Gi Joo Yang, Seoul (KR); Taehyung Lim, Seoul (KR); Eun Ji Kum, Gyeonggi-do (KR)

(72) Inventors: Dae Woon Lim, Seoul (KR); Gi Joo Yang, Seoul (KR); Taehyung Lim, Seoul (KR); Eun Ji Kum, Gyeonggi-do (KR)

(73) Assignee: Dongguk University Industry-Academic Cooperate Foundation, Seoul (KR)

(21) Appl. No.: 13/643,479

(22) PCT Filed: Apr. 29, 2011
(86) PCT No.: PCT/KR11/03219

§ 371 Date: Dec. 20, 2012

(30) Foreign Application Priority Data
Apr. 29, 2010 (KR) 10-2010-0040126

(51) Int. Cl. H04L 9/28

(52) U.S. Cl. CPC H04L 9/28
USPC 380/28

(57) ABSTRACT

Provided is an encryption system, which includes: an encryption round calculation unit for encrypting a plain text; and a substitution unit provided at the encryption round calculation unit and having a plurality of S-boxes defined by a discrete chaos function using each of a plurality of key values as a parameter and performing a substitution calculation process to each of words of the plain text divided by the number of the plurality of key values. Since a discrete chaos function becomes a standard for an S-box design and an encryption calculation operation is performed by a plurality of S-boxes, the encryption system may be applied to a system having a small computational complexity.

### TECHNICAL FIELD

The present disclosure relates to an encryption system, and more particularly, to an encryption system using a discrete chaos function, which may propose a standard for an S-box design and be applied to a system having a small computational complexity.

### BACKGROUND ART

As the network communication and electronic commerce have developed, security becomes more important. A technique of encrypting information by using an encryption system is one of security methods.

Chaos functions have been proposed in various encryption systems since characteristics of chaos functions having an output value not predicted and seemingly random are in agreement with characteristics demanded by a safe encryption system. However, since most encryption systems require a very high level of computational complexity, they may not be applied to a lightweight system without change.

### DISCLOSURE

### Technical Problem

The present disclosure is directed to providing an encryption system, which may propose a standard for an S-box design and be applied to a lightweight system having a small computational complexity.

### Technical Solution

In one general aspect, the present disclosure provides an encryption system, which includes: an encryption round calculation unit for encrypting a plain text; and a substitution unit provided at the encryption round calculation unit and having a plurality of S-boxes defined by a discrete chaos function using each of a plurality of key values as a parameter and performing a substitution calculation process to each of words of the plain text divided by the number of the plurality of key values.

According to an embodiment of the present disclosure, the plurality of key values of the plurality of S-boxes may be defined according to an equation below:

$${S}_{{K}_{i}} ( x ) = \{ \begin{matrix}⌈ \frac{{2}^{N}}{{K}_{i}} ( x + 1 ) ⌉ - 1 , & 0 \leq x < {K}_{i} \\ ⌊ \frac{{2}^{N}}{{2}^{N} - {K}_{i}} ( {2}^{N} - x - 1 ) ⌋ , & {K}_{i} \leq x < {2}^{N}\end{matrix} \qquad [ Equation ]$$

where S_{K}_{ᵢ}(X) is any one of the plurality of S-boxes, Kᵢ and any one of the plurality of key values.

The plurality of S-boxes may be a table where an input and a result of the equation according to the input correspond to each other.

The encryption system may further include a permutation unit provided at the encryption round calculation unit and having a plurality of permutation functions for performing a permutation calculation operation with respect to an output of each of the plurality of S-boxes.

The plurality of permutation functions may be defined by the same number of words as the number of the plurality of key values and an equation below;

γᵢ(X)=(⊕ₖ₌₀⁷(mᵢ·Xₖ>>k))<<i [Equation]

where γᵢ(X) represents any one of the plurality of permutation functions, << represents a right rotation, >> represents a left rotation, ⊕ represents an exclusive OR between bits, · represents an AND operation between bits, mᵢ represents any one of input words (m₀-m_{N}), and k represents a value set by a user.

### Advantageous Effects

According to the present disclosure, since a discrete chaos function becomes a standard for an S-box design and an encryption calculation operation is performed by a plurality of S-boxes, the present disclosure may be applied to a system having a small computational complexity.

### DESCRIPTION OF DRAWINGS

FIG. 1 is a graph showing a tent function used in a conventional encryption system using a chaos function;

FIG. 2 is a block diagram showing an encryption system having a substitution-permutation network (SPN) structure;

FIG. 3 is a diagram for illustrating a process of performing a first round when an input value X is 0000 0000 0000 0000 and a key value K¹ is 1111 1111 1111 1111, in the case the SPN system of FIG. 2 uses an S-box shown in Table 1;

FIG. 4 is a diagram showing an SPN system according to an embodiment of the present disclosure;

FIG. 5 is a block diagram showing an encryption system using a discrete tent function according to an embodiment of the present disclosure;

FIG. 6 is a graph showing a result of a uniformity test for a plain text of the discrete encryption system according to an embodiment of the present disclosure;

FIG. 7 is a graph showing a result of a uniformity test for a key of the discrete encryption system according to an embodiment of the present disclosure;

FIG. 8 is a graph showing a result of a sensitivity test of a cipher text with respect to a plain text of the discrete encryption system according to an embodiment of the present disclosure; and

FIG. 9 is a graph showing a result of a sensitivity test of a cipher text with respect to a key of the discrete encryption system according to an embodiment of the present disclosure

### BEST MODE

An encryption system using a discrete chaos function according an embodiment of the present disclosure includes an encryption round calculation unit for encrypting a plain text, and a substitution unit provided at the encryption round calculation unit and having a plurality of S-boxes defined by a discrete chaos function using each of a plurality of key values as a parameter and performing a substitution calculation process to each of words of the plain text divided by the number of the plurality of key values.

### MODE FOR INVENTION

Hereinafter, the present disclosure will be described in more detail based on embodiments of the present disclosure. However, the embodiments of the present disclosure are for better understanding of the present disclosure, and it will be obvious to those having ordinary skill in the art that the scope of the present disclosure is not limited to the embodiments.

An encryption system using a chaos function uses a chaos function having an output value not predicted and seemingly random. As an encryption system using a chaos function, there is an encryption system using a tent function. The encryption system using a tent function performs encryption and decryption using a tent function and its reversed function.

In an embodiment of the present disclosure, among chaos functions having a small computational complexity to be applicable to a lightweight encryption system, a tent function simplest and most widely used will be applied. The tent function is a kind of one-dimensional piecewise linear maps. This function uses the region [0,1] as a domain and has a range of the same magnitude, and it has only a single parameter α.

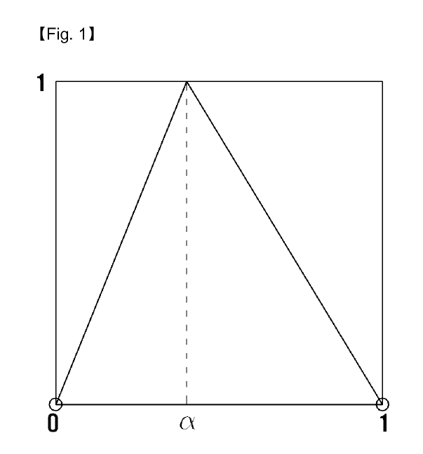

FIG. 1 is a graph showing a tent function used in a conventional encryption system using a chaos function.

The tent function is defined according to Equation 1 and Equation 2, and decryption is performed by using a tent function expressed by the graph of FIG. 1, and encryption is performed by using a reversed function of the tent function as defined by Equation 2. By successively taking one of output values generated when the reversed function of the tent function like Equation 2 is applied to a plain text, encryption is performed to the plain text. By successively applying the tent function like Equation 1 to a cipher text, the cipher text is decrypted.

$${f}_{α} ( x ) = \{ \begin{matrix}\frac{x}{α} , & 0 \leq x \leq α \\ \frac{x - 1}{α - 1} , & α < x \leq 1\end{matrix} \qquad [ Equation 1 ]$$

where the domain (x) is a real number between 0 and 1, and α is a parameter.

f_{α}⁻¹(y)=αy or 1+(α−1)y [Equation 2]

were the domain (y) is a real number between 0 and 1, and α is a parameter.

However, in the encryption system using the above tent function, a tent function and a reversed function of the tent function do not have a relation of one-to-one function, an input value and an output value of each round are not integers but real numbers, and the tent function and the reversed function of the tent function are a piecewise linear map. Therefore, this encryption system is weak against differential cryptanalysis.

The encryption system using a tent function will be described below in more detail.

f_{α}ⁿ has 2ⁿ number of input values corresponding to a single output value, and f_{α}⁻ⁿ has 2ⁿ number of output values with respect to a single input value. In addition, since x=f_{α}(f_{α}⁻¹(x)), it may be easily understood that x=f_{α}ⁿ(f_{α}⁻ⁿ(x)).

A simplest format of an encryption system using a tent function is as follows.
secret key: parameter α
encryption: a plain text p is obtained by using a message to be encrypted.
   At this time, p is a real number having a value between 0 and 1. Next, f_{α}⁻¹ is successively performed as shown in the equation below to obtain a cipher text c. At this time, between two output values generated whenever f_{α}⁻¹ is applied, only one value is taken.

c=f_{α}⁻¹(f_{α}⁻¹( . . . f_{α}⁻¹(p) . . . ))=f_{α}⁻ⁿ(p)
decryption: f_{α} is successively performed with the received message c as an input as shown in the equation below to obtain a plain text p.

p=f_{α}(f_{α}( . . . (f_{α}(c) . . . )))=f_{α}ⁿ(c)

However, this method has several drawbacks. First, f_{α} and f_{α}⁻¹ are not a one-to-one function, second, an input value and an output value of each round are not integers but real numbers, and finally, f_{α} and f_{α}⁻¹ are piecewise linear. Therefore, this method is weak against linear or differential cryptanalysis.

In order to overcome such drawbacks, an encryption system using a discrete tent function, which uses a discrete tent function as defined in Equation 3 to encrypt a plain text and use a reversed function of the discrete tent function as defined in Equation 4 to decrypt a cipher text, will be described below.

$${F}_{A} ( X ) = \{ \begin{matrix}⌈ \frac{M}{A} X ⌉ , & 1 \leq X \leq A \\ ⌊ \frac{M}{M - A} ( M - X ) ⌋ + 1 , & A < X \leq M\end{matrix} \qquad [ Equation 3 ]$$

where the domain (X) is an integer between 1 and M, and A is a parameter of the discrete tent function. A has an integer value between 1 and M.

$${F}_{A}^{- 1} ( Y ) = \{ \begin{matrix}{X}_{1 ,} & m ( Y ) = Y , \frac{{X}_{1}}{A} > \frac{M - {X}_{2}}{M - A} \\ {X}_{2 ,} & m ( Y ) = Y , \frac{{X}_{1}}{A} < \frac{M - {X}_{2}}{M - A} \\ {X}_{1 ,} & m ( Y ) = Y + 1\end{matrix} \qquad [ Equation 4 ]$$

where the domain (Y) is an integer between 1 and M, A is a parameter of the discrete tent function, and X₁, X₂ and m(Y) are defined as follows.

$${X}_{1} ≡ ⌊ {M}^{- 1} AY ⌋$$

$${X}_{2} ≡ ⌈ ( {M}^{- 1} A - 1 ) Y + M ⌉$$

$$m ( Y ) ≡ Y + ⌊ \frac{AY}{M} ⌋ - ⌈ \frac{AY}{M} ⌉ + 1$$

The discrete tent function defined as above has a one-to-one relationship and satisfies properties of the chaos function.

Next, an encryption system having a discrete tent function based on the above will be described.

A plain text P is obtained by using a message to be encrypted. At this time, P has an integer value, and a maximum value of available plain text is set to be M. The encryption system using a discrete tent function defined above will be defined as follows.
secret key: parameter A
encryption: F_{A} is successively performed as shown in the equation below with the plain text P as an initial value to obtain a cipher text C.

C=F_{A}(F_{A}( . . . F_{A}(P) . . . ))=F_{A}ⁿ(P)
decryption: F_{A}⁻¹ is successively performed as shown in the equation below with the received message C as an input to obtain a decrypted plain text P.

P=F_{A}⁻¹(F_{A}⁻¹( . . . (F_{A}⁻¹(C) . . . )))=F_{A}⁻ⁿ(C)

The proposed encryption system using a discrete tent function may solve the problems of an encryption system having a tent function with a real number. However, this system demands a very high level of computational complexity since a chaos function is repeatedly performed with respect to the entire plain texts to be encrypted.

In addition, the encryption system using a discrete chaos function demands a very high level of computational complexity since the chaos function operations are repeatedly performed with respect to the entire plain texts to be encrypted. In other words, in case of 64-bit encryption system, in order to apply the discrete chaos function, real number operations composed of multiplications and divisions should be repeatedly performed with respect to integers with a maximum size of 2⁶⁴. Therefore, it is not easily to apply the encryption system using a discrete tent function to a system having a small computational complexity.

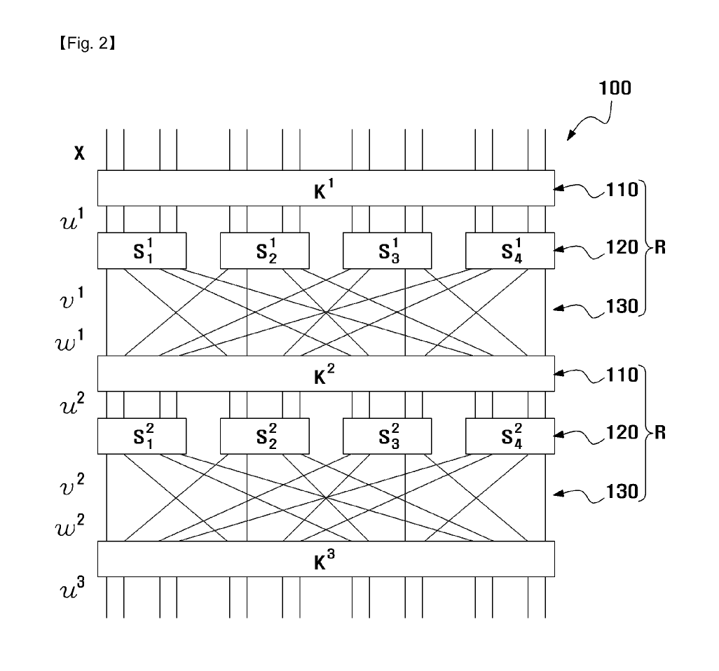

FIG. 2 is a block diagram showing an encryption system having a substitution-permutation network (SPN) structure.

Table 1 shows a table of S-boxes used for the encryption system using an SPN structure. In Table 1, z represents an input value, and πₛ(z) represents an output value.

TABLE 1

| z: INPUT | πₛ(z): OUTPUT |
|---|---|
| 0000 | 1110 |
| 0001 | 0100 |
| 0010 | 1101 |
| 0011 | 0001 |
| 0100 | 0010 |
| 0101 | 1111 |
| 0110 | 1011 |
| 0111 | 1000 |
| 1000 | 0011 |
| 1001 | 1010 |
| 1010 | 0110 |
| 1011 | 1100 |
| 1100 | 0101 |
| 1101 | 1001 |
| 1110 | 0000 |
| 1111 | 0111 |

Referring to FIG. 2, the encryption system 100 having an SPN structure includes a key calculation layer 110, a substitution layer 120 and a permutation layer 130. The encryption system having an SPN structure performs a round composed of three stages (1)-(3) below several times to encrypt a plain text.

(1) First, if an input value X is received, the key calculation layer 110 performs exclusive OR (XOR) operation with respect to the input value X and a key value K.

(2) After that, the substitution layer 120 performs substitution with respect to the result of the exclusive OR (XOR) operation by using an S-box expressed as a table as shown in FIG. 2.

(3) Finally, the permutation layer 130 performs permutation with respect to the substitution result so that an input of a next round is input.

However, the encryption system having an SPN structure has a drawback in that an optimal S-box should be experimentally made since no design standard for the S-box is present.

In an SPN system, the round described above is repeatedly performed as much as N times. In case the input value is z, the S-box may be expressed as output value πₛ(z) accordingly, and Table 1 is an example of the S-box function πₛ(z) which outputs 4 bits with respect to 4-bit input.

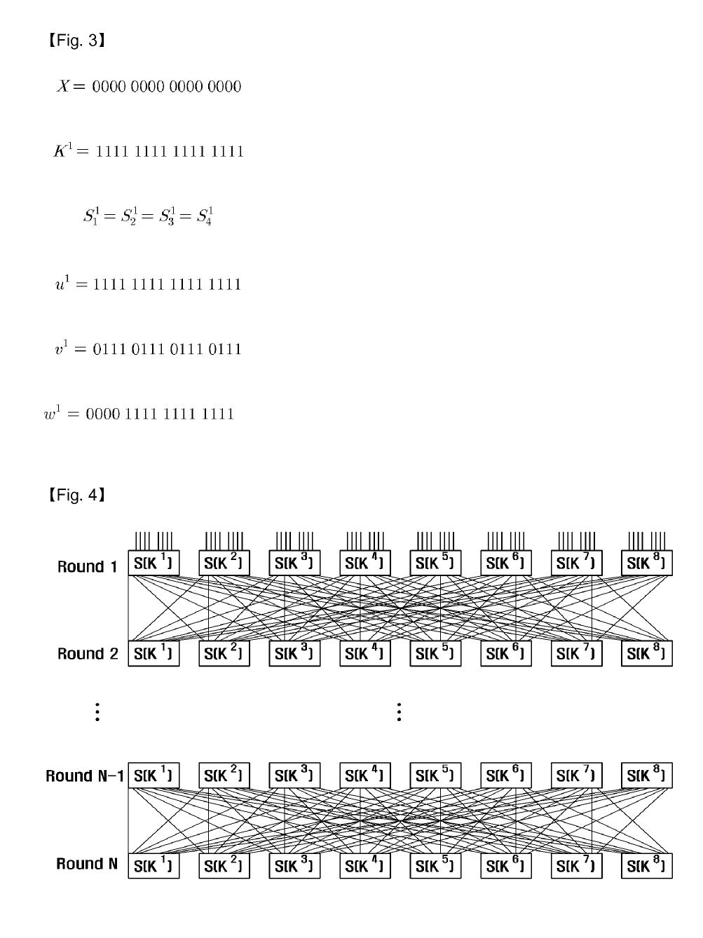

FIG. 3 is a diagram for illustrating a process of performing a first round when an input value X is 0000 0000 0000 0000 and a key value K¹ is 1111 1111 1111 1111, in the case the SPN system of FIG. 2 uses an S-box shown in Table 1.

u¹ represents a result of performing XOR operation to the input value and the key value, and u¹ will be an input value of the S-box which performs substitution. Next, v¹ represents an output value corresponding to the input value and the output value according to the input value may be checked in Table 1 above. Finally, w¹ is a substitution result of v¹ and becomes an input value of the next round.

Even though a key and an S-box are designed separately in the SPN system shown in FIG. 2, in the SPN system according an embodiment of the present disclosure, a key value is used as a parameter for designing an S-box, and a chaos function is repeatedly performed as much as N times with respect to all plane texts to be encrypted.

The present disclosure is directed to disclosing a new lightweight encryption system which uses a discrete tent function but does not requires a high level of computational complexity even though a system having a small computational complexity uses a 64-bit encryption system.

The encryption system according to an embodiment of the present disclosure is designed to receive a plain text of 64 bits as an input and outputs a cipher text of 64 bits by using a 64-bit key. The transformation of each round is composed of substitution and permutation. The encryption is performed by repeating the same round transformation 16 times. In addition, the decryption is performed by repeating very similar round transformation.

FIG. 4 shows an SPN system according to an embodiment of the present disclosure.

The SPN system according to an embodiment of the present disclosure will be described in detail with reference to FIG. 4.

1. Substitution Sₖ

Assuming that a key of 64 bits to be used for the encryption system is K, K may be divided into 8 sub-keys.

K=(K₀K₁ . . . K₇)

For each sub-key Kᵢ, 0≦i≦7, the following function is defined.

$${S}_{{K}_{i}} ( x ) = \{ \begin{matrix}⌈ \frac{256}{{K}_{i}} ( x + 1 ) ⌉ - 1 , & 0 \leq x < {K}_{i} \\ ⌊ \frac{256}{256 - {K}_{i}} ( 256 - x - 1 ) ⌋ , & {K}_{i} \leq x < 256\end{matrix}$$

S_{K}_{ᵢ} is a one-to-one function, and its reversed function is S_{K}_{ᵢ}⁻¹.

Now, S_{K} is defined by using S_{K}_{ᵢ}. 64-bit message X which is an input of S_{K} is divided into 8 words as follows.

X=(X₀X₁ . . . X₇)

At this time, S_{K} is defined as follows.

S_{K}(X)=(S_{K}_{₀}(X₀)S_{K}_{₁}(X₁) . . . S_{K}_{₇}(X₇))

In a similar way, a reversed function S_{K}⁻¹ of S_{K} is defined as follows.

S_{K}⁻¹(X)=(S_{K}_{₀}⁻¹(X₀)S_{K}_{₁}⁻¹(X₁) . . . S_{K}_{₇}⁻¹(X₇))

2. Permutation π

First, a function γᵢ, 0≦i≦7 for receiving a message of 64 bits as an input and giving an output of 8 bits is defined. At this time, the input X is defined in the same way as the case of the substitution function, and 8 words are defined as follows.

m₀=10000000₂, m₁=01000000₂,

m₂=00100000₂, m₃=00010000₂,

m₄=00001000₂, m₅=00000100₂,

m₆=00000010₂, m₇=00000001₂.

In this case, γᵢ is defined as follows.

γᵢ(X)=(⊕ₖ₌₀⁷(mᵢ·Xₖ>>k))<<i

Here, << and >> represents right and left rotations, respectively, ⊕ represents an XOR operation between bits, and · represents an AND operation between bits.

Now, γ is defined as follows by using γᵢ.

γ(X)=(γ₀(X)γ₁(X) . . . γ₇(X))

Since γ is a one-to-one function, a reversed function is present. Finally, π(X)=γ⁻¹(X) and α⁻1(X)=γ(X) are defined.

3. Encryption/Decryption

Round functions for encryption and decryption are defined as follows.

R_{K}=π∘Sₖ

R_{K}⁻¹=Sₖ⁻¹∘π⁻¹

Finally, encryption and decryption are performed through the following process.

Eₖ(X)=R_{K}¹⁶(X)

D_{K}(Y)=R_{K}⁻¹⁶(Y)

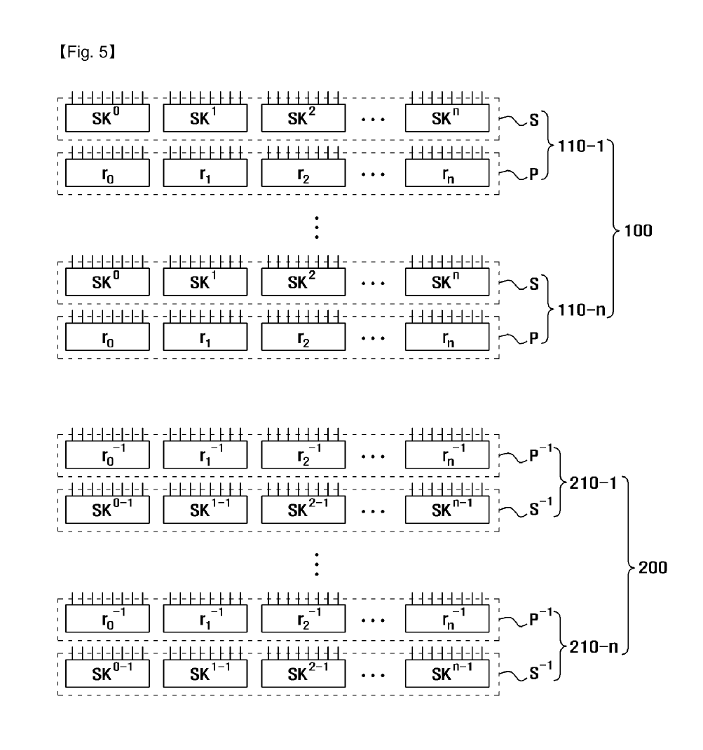

FIG. 5 is a block diagram showing an encryption system using a discrete tent function according to an embodiment of the present disclosure.

Referring to FIG. 5, the encryption system according to an embodiment of the present disclosure includes an encryption unit 100 having a plurality of encryption round calculation units 110-1˜100-n for performing round operations to encrypt a plain text, and a decryption unit 200 having a plurality of decryption round operation units 210-1˜210-n for performing round operation to decrypt a cipher text.

Each of the plurality of encryption round calculation units 110-1˜100-n includes a substitution unit S having a plurality of S-boxes SK⁰-SK^{N} for performing a substitution calculation process to each of words X₀-X_{N} of a plain text input X divided by the number of a plurality of key values K₀-K_{N} with each of the plurality of key values K₀-K_{N} as a parameter, and a permutation unit P having a plurality of permutation functions r₀-r_{N} for performing a permutation calculation operation with respect to the output of each of the plurality of S-boxes SK⁰-SK^{N} of the substitution unit S.

Each of the plurality of S-boxes SK⁰-SK^{N} is defined by each of the plurality of key values K₀-K_{N} and a discrete chaos function as in Equation 5 below. Here, the plurality of key values K₀-K_{N} are set by the user. The number of plurality of key values K₀-K_{N} is selected by a designer of the encryption system according to an embodiment of the present disclosure.

$${S}_{{K}_{i}} ( x ) = \{ \begin{matrix}⌈ \frac{{2}^{N}}{{K}_{i}} ( x + 1 ) ⌉ - 1 , & 0 \leq x < {K}_{i} \\ ⌊ \frac{{2}^{N}}{{2}^{N} - {K}_{i}} ( {2}^{N} - x - 1 ) ⌋ , & {K}_{i} \leq x < {2}^{N}\end{matrix} \qquad [ Equation 5 ]$$

where S_{K}_{ᵢ}(X) is any one of the plurality of S-boxes, and Kᵢ is any one of the plurality of key values.

Each of the plurality of S-boxes SK⁰-SK^{N} performs a substitution calculation process through the discrete tent function as in Equation 5 with respect to each of the words K₀-K_{N}.

Meanwhile, each of the plurality of S-boxes SK⁰-SK^{N} may be implemented as a table corresponding to Equation 5. In other words, this may be implemented as a table where a specific input X and a calculation value of Equation 5 by the specific input X correspond to each other.

Each of the plurality of permutation functions γ₀-γ_{N} is defined by the same number of words m₀-m_{N} as the number of the plurality of key values K₀-K_{N} and Equation 6 below.

γᵢ(X)=(⊕ₖ₌₀⁷(mᵢ·Xₖ>>k))<<i [Equation 6]

where γᵢ(X) represents any one of the plurality of permutation functions, << represents a right rotation, >> represents a left rotation, ⊕ represents an exclusive OR between bits, · represents an AND operation between bits, mᵢ represents any one of input words (m₀-m_{N}), and k represents a value set by a user.

Each of the plurality of permutation functions r₀-r_{N} performs a permutation calculation operation with respect to the output X₀-Xₖ of each of the plurality of S-boxes SK¹-SK^{N}.

The encryption unit 100 performs a plurality of round operations with respect to a plain text through each of the plurality of round operation units 110-1˜110-n to encrypt the plain text.

Each of the plurality of decryption round operation units 210-1˜210-n includes an inverse permutation unit P⁻¹ having a plurality of inverse permutation functions r₀⁻¹˜r_{N}⁻¹ for inversely substituting each of a plurality of words of a plurality of cipher text inputs, and an inverse substitution unit S⁻¹ having a plurality of inverse S-boxes SK⁰⁻¹˜SK^{N-1} for performing an inverse substitution calculation process with respect to each of the words of the output of the inverse permutation unit P⁻¹.

Here, each of the plurality of inverse permutation functions r₀⁻¹-r_{N}⁻¹ is a reversed function of each of the plurality of permutation functions r₀-r_{N}, and each of the plurality of inverse S-boxes SK⁰⁻¹-SK^{N-1} is a reversed function of Equation 6 which defines each of the plurality of S-boxes SK⁰-SK^{N}. Therefore, the inverse permutation unit P⁻¹ and the inverse substitution unit S⁻¹ will not be described in detail here.

The decryption unit 200 performs a plurality of decryption round operations with respect to a cipher text through the plurality of decryption round operation units 210-1˜210-n to decrypt the cipher text.

Hereinafter, among effects of the encryption system according to an embodiment of the present disclosure, computational complexity and safety will be described in more detail.

1. Computational Complexity

In the case a conventional encryption method using a chaos function is applied to a 64-bit encryption system, real number operations including divisions and multiplications are required for integer values with a size of 2⁶⁴ in order to perform each round function. Meanwhile, in case of using the method proposed in the present disclosure, each round function may be performed by conducting multiplications and divisions 8 times, respectively, for integer values with a size of 2⁸. Even though a substitution process should be additionally performed, different from an existing method, this does not give a serious burden on the computational complexity since the substitution process be performed very simply when being implemented by hardware or software. In addition, if input values and output values of a substitution function S_{K}_{ᵢ} are made as a table and stored in a memory, encryption and decryption may be performed with a very small amount of operations by using the table.

2. Safety

Generally, a safe encryption system should satisfy the following conditions.
uniformity (U-P) of distribution of a cipher text with respect to a plain text: when a plain text continuously changes, a cipher text resultantly generated should be distributed over the entire region of the cipher text as uniformly as possible.
uniformity (U-K) of distribution of a cipher text with respect to a key: when a key value continuously changes, a cipher text resultantly generated should be distributed over the entire region of the cipher text as uniformly as possible.
sensitivity (S-P) of a cipher text with respect to a plain text: a cipher text should have sensitivity with respect to the change of a plain text. In other words, even though only 1 bit of the plain text changes, a cipher text with an entirely different format should be generated.
sensitivity (S-K) of a cipher text with respect to a key: a cipher text should have sensitivity with respect to the change of a key value. In other words, even though only 1 bit of the key value changes, a cipher text with an entirely different format should be generated.

Next, statistical experimental results are suggested to show the encryption system proposed in the present disclosure satisfies the above conditions. Through these test results, the effects of the present disclosure may be revealed.
Uniformity test (U-P, U-K)
In the uniformity test of a cipher text with respect to a plain text, a region [1,M] where the cipher text is distributed is divided into b number of successive sections. At this time, the i^{th} section is called Iᵢ.
For the U-P test, values of n number of cipher texts are obtained as follows.

Eₖ(X), Eₖ(X+1), . . . , Eₖ(X+n−1)

In addition, a frequency n, is obtained by reckoning the number of cipher texts included in Iᵢ.

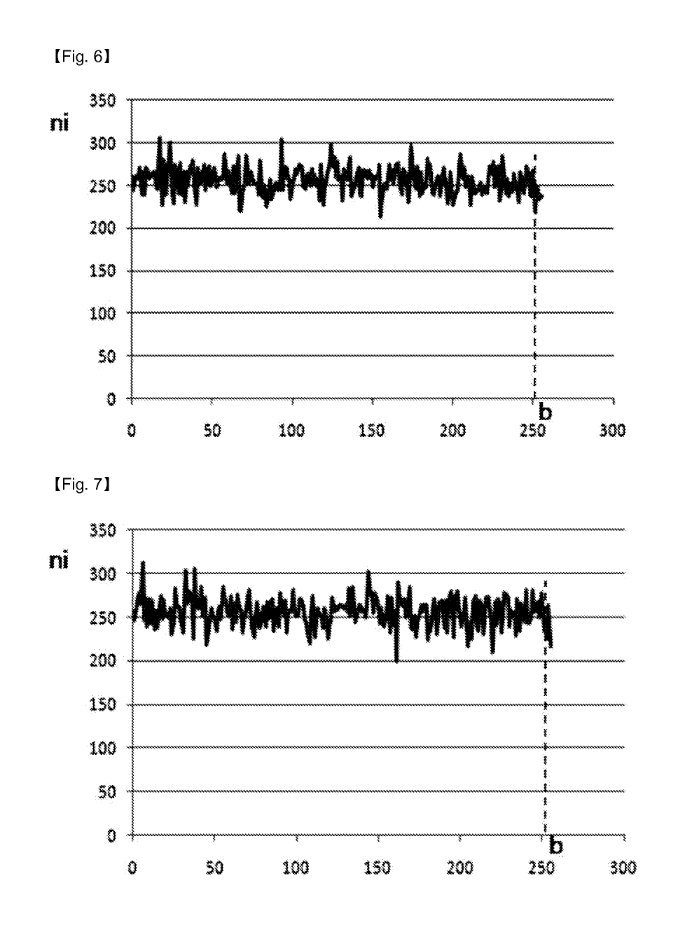

FIG. 6 is a graph showing a result of the uniformity test for a plain text of the discrete encryption system according to an embodiment of the present disclosure. FIG. 6 is a graph showing a frequency of cipher texts included in each of successive sections when M is 2⁶⁴, b is 2⁸, and n is 2¹⁶. As shown in FIG. 6, by the discrete encryption system according to an embodiment of the present disclosure, the frequency of cipher texts included in each of successive sections is generally uniform, and so the uniformity of a cipher text to a plain test is excellent.

For the U-K test, values of n number of cipher texts are obtained as follows, and then the frequency n, is obtained, similar to the case of the U-P test.

E_{γ}_{^{−1}}_{(γ(K))}(X), E_{γ}_{^{−1}}_{(γ(K)+1)}(X), . . . , E_{γ}_{^{−1}}_{(γ(K)+n-1)}(X)

FIG. 7 is a graph showing a result of the uniformity test for a key of the discrete encryption system according to an embodiment of the present disclosure. FIG. 7 is a graph showing the frequency of cipher texts included in each of successive sections when M is 2⁶⁴, b is 2⁸, and n is 2¹⁶. As shown in FIG. 7, by the discrete encryption system according to an embodiment of the present disclosure, the frequency of cipher texts included in each of successive sections is generally uniform, and so the uniformity of a cipher text to a key is excellent.
A standard deviation is obtained as follows.

$$δ = \sqrt{\frac{{\sum }_{i = 1}^{b} {( {n}_{i} - \frac{n}{b} )}^{2}}{b}}$$

FIGS. 6 and 7 show a frequency n, obtained with respect to a specific input value X(K). A standard deviation obtained for several input values is exhibited as about 16, identically for both cases of U-P and U-K.
Sensitivity test (S-P, S-K)
In the sensitivity test of a cipher text with respect to a plain text, a region [1,M] where the cipher text is distributed is divided into b number of successive sections. At this time, the i^{th} section is called Iᵢ.
For the S-P test, values of n number of cipher text pairs are obtained.

{Eₖ(X₁), Eₖ(X₁+1)}, . . . , {Eₖ(Xₙ), Eₖ(Xₙ+1)}

In addition, a frequency nᵢⱼ is obtained by reckoning the number of cipher texts included in {Iᵢ,Iⱼ}.

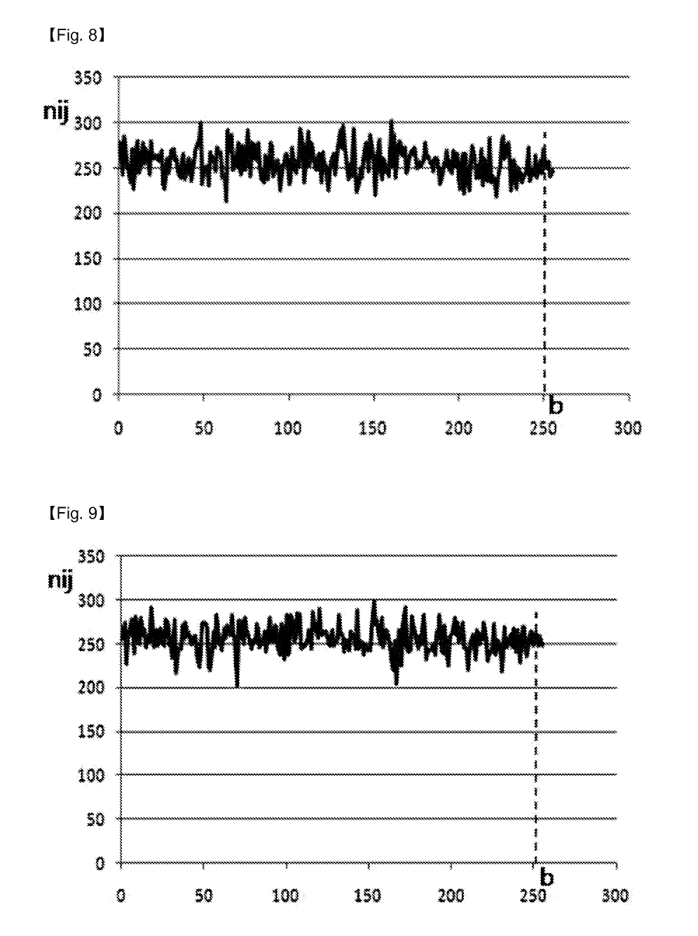

FIG. 8 is a graph showing a result of the sensitivity test for a plain text of the discrete encryption system according to an embodiment of the present disclosure. FIG. 8 is a graph showing a frequency of cipher text pairs included in each of successive sections when M is 2⁶⁴, b is 2⁸, and n is 2¹⁶. As shown in FIG. 8, by the discrete encryption system according to an embodiment of the present disclosure, the frequency of cipher texts included in each of successive sections is generally uniform, and so the uniformity of a cipher text to a plain test is excellent.

For the S-K test, values of n number of cipher text pairs are obtained as follows, and then the frequency nᵢⱼ is obtained, similar to the case of the S-P test.

{E_{γ}_{^{−1}}_{(γ(K}_{₁}₎₎(X), E_{γ}_{^{−1}}_{(γ(K}_{₁}₎₊₁₎(X)}, . . . , {E_{γ}_{^{−1}}_{(γ(K}_{ₙ}₎₎(X), E_{γ}_{^{−1}}_{(γ(K}_{ₙ}₎₊₁₎(X)}

In the sensitivity test of a cipher text with respect to a key, a region [1,M] where the cipher text is distributed is divided into b number of successive sections, n number of cipher test pairs are obtained like the cipher text 3, and a frequency nᵢⱼ of cipher text pairs included in each section is obtained.

FIG. 9 is a graph showing a result of the sensitivity test of a cipher text with respect to a key of the discrete encryption system according to an embodiment of the present disclosure. FIG. 9 is a graph showing the frequency of cipher text pairs included in each of successive sections when M is 2⁶⁴, b is 2⁸, and n is 2¹⁶. As shown in FIG. 9, the frequency of cipher texts included in each of successive sections is generally uniform, and so the uniformity of a cipher text to a key is excellent.
A standard deviation is obtained as follows.

$$δ = \sqrt{\frac{{\sum }_{i = 1}^{b} {\sum }_{j = 1}^{b} {( {n}_{ij} - \frac{n}{{b}^{2}} )}^{2}}{{b}^{2}}}$$

FIGS. 8 and 9 show a frequency n, obtained with respect to a specific S-P test ad S-K test. A standard deviation obtained by repeating S-P tests and S-K tests several times is exhibited as about 16.

Though the present disclosure has been described based on limited embodiments and drawings as well as specific matters such as detailed components, they are just for better understanding of the present disclosure, and the present disclosure is not limited to the embodiments but various changes and modifications can be made to the present disclosure by those having ordinary skill in the art. Therefore, the scope of the present disclosure should not be limited to the above embodiments but equivalents within the scope of the appended claims should be interpreted as belong to the present disclosure.

1. An encryption system, comprising:
an encryption round calculation unit for encrypting a plain text; and
a substitution unit provided at the encryption round calculation unit and having a plurality of S-boxes defined by a discrete chaos function using each of a plurality of key values as a parameter and performing a substitution calculation process to each of words of the plain text divided by the number of the plurality of key values.

2. The encryption system according to claim 1,
wherein the plurality of key values of the plurality of S-boxes are defined according to an equation below:
$${S}_{{K}_{i}} ( x ) = \{ \begin{matrix}⌈ \frac{{2}^{N}}{{K}_{i}} ( x + 1 ) ⌉ - 1 , & 0 \leq x < {K}_{i} \\ ⌊ \frac{{2}^{N}}{{2}^{N} - {K}_{i}} ( {2}^{N} - x - 1 ) ⌋ , & {K}_{i} \leq x < {2}^{N}\end{matrix} \qquad [ Equation ]$$
where S_{K}_{ᵢ}(X) is any one of the plurality of S-boxes, Kᵢ and any one of the plurality of key values.

3. The encryption system according to claim 2,
wherein the plurality of S-boxes are a table where an input and a result of the equation according to the input correspond to each other.

4. The encryption system according to claim 1, further comprising a permutation unit provided at the encryption round calculation unit and having a plurality of permutation functions for performing a permutation calculation operation with respect to an output of each of the plurality of S-boxes.

5. The encryption system according to claim 4, wherein the plurality of permutation functions are defined by the same number of words as the number of the plurality of key values and an equation below;
γᵢ(X)=(⊕ₖ₌₀⁷(mᵢ·Xₖ>>k))<<i [Equation]
where γᵢ(X) represents any one of the plurality of permutation functions, << represents a right rotation, >> represents a left rotation, ⊕ represents an exclusive OR between bits, · represents an AND operation between bits, mᵢ represents any one of input words (m₀-m_{N}), and k represents a value set by a user.
